(19) United States
(12) Patent Application Publication
(10) Pub. No.: US 2025/0202262 A1
(43) Pub. Date: Jun. 19, 2025

(54) HYBRID LITHIUM-ION ULTRACAPACITOR BATTERY

(71) Applicant: Aptiv Technologies AG, Schaffhausen (CH)

(72) Inventors: Robert DEUTSCH, SHELBY TOWNSHIP, MI (US); Mary PATTERSON, Carmel, IN (US)

(21) Appl. No.: 18/965,080

(22) Filed: Dec. 2, 2024

Related U.S. Application Data
(60) Provisional application No. 63/611,460, filed on Dec. 18, 2023.
(60) Provisional application No. 63/552,711, filed on Feb. 13, 2024.

(51) Int. Cl. H02J 7/00; H02J 7/34

(52) U.S. Cl. CPC H02J 7/00714; H02J 7/0048; H02J 7/005; H02J 7/342; H02J 7/345; H02J 2207/20

(57) ABSTRACT

A hybrid battery for supplying electric power to a vehicle includes a terminal, one or more lithium-ion cells, one or more ultracapacitor cells, a DC/DC converter, and a controller. The one or more lithium-ion cells are connected to supply a first current to the terminal. The DC/DC converter is coupled in-series between the terminal and the one or more ultracapacitor cells. The one or more ultracapacitor cells and the DC/DC converter are connected to supply a second current to the terminal. The lithium-ion cells are connected in parallel with the one or more ultracapacitor cells and the DC/DC converter. The controller is in communication with the DC/DC converter to selectively modify the second current provided to the terminal.

### CROSS-REFERENCE TO RELATED APPLICATIONS

This application claims the benefit of and priority to U.S. provisional application 63/611,460, titled “HYBRID LITHIUM ION ULTRACAPACITOR BATTERY”, filed Dec. 18, 2023, and U.S. provisional application 63/552,711, titled “HYBRID LITHIUM-ION ULTRACAPACITOR BATTERY”, filed Feb. 13, 2024, the contents of which are both incorporated by reference herein.

### BACKGROUND

The present disclosure relates generally to a hybrid battery system and methods of controlling the hybrid battery system.

In general, lithium-ion batteries and lead acid batteries supply electric power to vehicular systems. Lead acid batteries have adverse implications on the environment, whereas lithium-ion batteries can be recycled or disposed of with little to no environmental impact. Therefore, it would be beneficial to eliminate the need for lead acid batteries in the automotive industry and replace lead acid batteries with lithium-ion batteries. However, lithium-ion batteries do not have the same high-power capabilities possessed by lead acid batteries. The lifetime of lithium-ion batteries is also a factor in automotive applications. It is well known that overcharging the lithium-ion battery cells, over-discharging the cells, charging or discharging the cells too rapidly, or charging the cells at cold temperatures will shorten the life of the cells. It is therefore difficult to rely solely on lithium-ion batteries to provide power to vehicle systems.

### OVERVIEW

According to some embodiments, a hybrid battery for supplying electric power to a vehicle includes a terminal, one or more lithium-ion cells, one or more ultracapacitor cells, a DC/DC converter, and a controller. The one or more lithium-ion cells are connected to supply a first current to the terminal. The DC/DC converter is coupled in-series between the terminal and the one or more ultracapacitor cells. The one or more ultracapacitor cells and the DC/DC converter are connected to supply a second current to the terminal. The lithium-ion cells are connected in parallel with the one or more ultracapacitor cells and the DC/DC converter. The controller is in communication with the DC/DC converter to selectively modify the second current provided to the terminal.

According to some embodiments, a method of delivery electric power to a vehicle includes providing a hybrid battery. The hybrid battery includes a terminal, a first and second current sensor, and a lithium-ion cell stack including one or more lithium-ion cells. An ultracapacitor is electrically connected to the lithium-ion cell stack. A DC/DC converter electrically coupled to the ultracapacitor. A controller communicates with the DC/DC converter to adjust an output voltage of the DC/DC converter. The method includes measuring a total output load on the battery with the first current sensor. An ultracapacitor output current is measured with the second current sensor. The output voltage of the DC/DC converter is adjusted with the controller to control a second current output from the ultracapacitor.

According to some embodiments, a vehicular battery system includes a hybrid battery, a battery management system (BMS), a capacitor management system (CMS), and an electronic controller. The hybrid battery includes an output terminal, a lithium-ion cell stack, and an ultracapacitor cell stack. A DC/DC converter is electrically coupled with the ultracapacitor cell stack. A first current sensor measures a first current at the output terminal. The battery management system (BMS) includes a battery sensor to measure one or more lithium-ion cell stack parameters. The capacitor management system (CMS) includes a capacitor sensor to measure one or more ultracapacitor cell stack parameters. The electronic controller communicates with the BMS, with the CMS, and with the DC/DC converter to adjust an output voltage of the DC/DC converter.

These and other examples and features of the present devices, systems, and methods will be set forth, at least in part, in the following Detailed Description. This Overview is intended to provide non-limiting examples of the present subject matter-it is not intended to provide an exclusive or exhaustive explanation. The Detailed Description below is included to provide further information about the present devices, systems, and methods.

### BRIEF DESCRIPTION OF DRAWINGS

This written disclosure describes illustrative embodiments that are non-limiting and non-exhaustive. Reference is made to illustrative embodiments that are depicted in the figures, in which:

FIG. 1 illustrates a diagrammatic view of a hybrid battery with a lithium-ion cell stack and an ultracapacitor cell stack, according to some embodiments.

FIG. 2 illustrates a schematic circuit diagram of a hybrid battery, according to some embodiments.

FIG. 3 illustrates a flow chart for a method of delivering electric power to a vehicle, according to some embodiments.

FIG. 4 illustrates a flow chart for a method of delivering electric power to a vehicle, according to some embodiments.

FIG. 5 illustrates an exemplary flow chart of input parameters for an ultracapacitor current to total output current function, according to some embodiments.

### DETAILED DESCRIPTION

According to some embodiments, this disclosure relates to a hybrid battery, i.e., a battery including a plurality of power cell stacks, with systems and methods of current allocation between the plurality of power cell stacks is described herein. In some embodiments the hybrid battery includes a lithium-ion cell stack including one or more lithium-ion cells configured to store energy and release energy (in the form of electric power) and an ultracapacitor cell stack including one or more ultracapacitor cells. Lithium-ion cells may be used in the hybrid battery because lithium-ion cells include high power-to-weight ratio, high energy efficiency, good high-temperature performance, long life, and low self-discharge. Lithium-ion cells are recyclable and generally have less adverse environmental effects than lead acid cells. The lithium-ion cell stack may be configured to store high amounts of energy and provide stable power output over long periods of time (i.e., minutes or hours). However, the lithium-ion cell stack may have intrinsic limitations with regard to high-power capabilities. For example, if a vehicular system requires a sudden surge of high-energy (e.g., an anti-lock braking system), the lithium-ion cell stack may be unsuited for high-energy, transient electrical loads. In some embodiments, the ultracapacitor cell stack is designed to provide high-energy, transient (i.e., less than 2 second) current to meet sudden surges of high-energy loads.

In some embodiments, the ultracapacitor cell stack is electrically coupled in-parallel to the lithium-ion cell stack. In some embodiments, a DC/DC converter is coupled in-series between the ultracapacitor cell stack and a terminal of the hybrid battery. The DC/DC converter selectively modifies an output current of the ultracapacitor cell stack. In some embodiments, a capacitor management system (CMS) receives communication from one or more sensors and a battery management system (BMS) receives communication from one or more sensor. The CMS and BMS communicate with a controller, which thereby selectively adjusts the output current of the ultracapacitor stack through control of the DC/DC converter.

In some embodiments, an output current from the ultracapacitor cell stack and an output current from the lithium-ion cell stack are intelligently allocated based on one or more measured lithium-ion parameters and/or one or more measured ultracapacitor parameters. The intelligent allocation of power between the ultracapacitor cell stack and the lithium-ion cell stack may improve performance of the hybrid battery and/or increase battery lifespan by minimizing battery degradation conditions (e.g., rapid charging of the lithium-ion cell stack at low temperature).

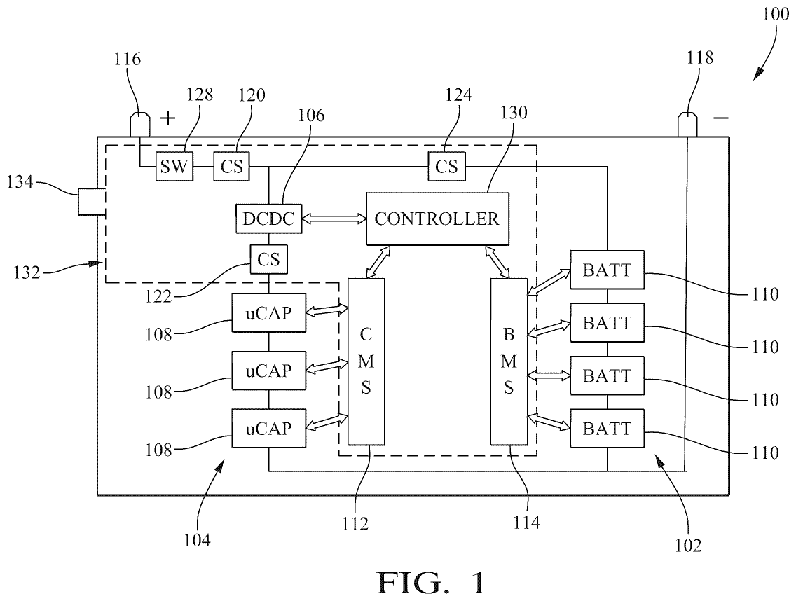

FIG. 1 illustrates a diagrammatic view of a hybrid battery 100 with a lithium-ion cell stack 102 and an ultracapacitor cell stack 104, according to some embodiments. The hybrid battery 100 may include a first terminal 116 (a positive (+) terminal in this example) and a second terminal 118 (a negative (−) terminal in this example). The first and second terminals 116, 118 may be electrically coupled to an electric distribution bus (not shown), wherein the hybrid battery 100 provides power to the electric distribution bus and receives charging power from the electric distribution bus. For example, one or more vehicle loads (i.e., an external electric load) may be connected to the electric distribution bus to receive power from the hybrid battery 100. Likewise, in some embodiments one or more power generation devices (e.g., alternator, generator, etc.) may be connected to the electric distribution bus to provide charging power to the hybrid battery 100.

The lithium-ion cell stack 102 may include one or more lithium-ion cells 110. In some embodiments, the one or more lithium-ion cells 110 may be electrically coupled in-series with each other. In other embodiments, the configuration of lithium-ion cells 110 could be 3S1P (3 cells in series and 1 parallel string), or it could be 3S2P (3 cells in series and 2 parallel strings), or in general xSyP. The lithium-ion cell stack 102 is connected to provide and receive power from the first terminal 116. When providing power, the lithium-ion cell stack 102 provides a first current to the first terminal 116.

The ultracapacitor cell stack 104 may include one or more ultracapacitor cells 108. In some embodiments, an ultracapacitor cell is a capacitive storage device having a capacitance of at least 100 farads. According to some embodiments, an ultracapacitor cell stack may include three 325 farad, 2.7 volt ultracapacitor cells connected in series, thereby providing the ultracapacitor cell stack with an equivalent capacitance of 108 farads and a working range of 5.0 to 8.4 volts. In some embodiments, the configuration of the ultracapacitor cell stack could be 3S1P (3 cells in series and 1 parallel string with 108F and 8.4V max), or it could be 3S2P (3 cells in series and 2 parallel strings with 217F and 8.4V max), or in general xSyP. The ultracapacitor cell stack may be configured to operate at currents up to 200 amperes. The ultracapacitor cell stack 104 is connected to provide and receive power from the first terminal 116. When providing power, the ultracapacitor stack 104 provides a second current to the first terminal 116.

In some embodiments, the ultracapacitor cell stack 104 and lithium-ion cell stack 102 are connected in parallel with one another between the respective terminals 116, 118 of the hybrid battery 100. The total current provided by the hybrid battery 100 is therefore a sum of the first current provided by the lithium-ion cell stack 102 and the second current provided by the ultracapacitor cell stack 104. Electrically connecting the ultracapacitor cell stack 104 and the lithium-ion cell stack 102 in-parallel may increase an available load current of the hybrid battery, and thus, increase the available load power (i.e., total output power) of the battery. Electrically connecting the ultracapacitor cell stack 104 and the lithium-ion cell stack 102 in-parallel may improve efficiency of current sharing between the ultracapacitor cell stack 104 and the lithium-ion cell stack 102. As described in more detail below, in some embodiments the hybrid battery 100 selectively controls whether current/power provided to the first terminal 116 is sourced from the lithium-ion cells 110, the ultracapacitor cells 108, or a combination of both. In some embodiments, the controller 130 monitors one or more parameters associated with operation conditions of the hybrid battery 100 or requested power from the vehicle (e.g., load current request) and/or one or more parameters with the lithium-ion cells 110 and/or the ultracapacitor cells 108 to determine how to allocate the distribution of power from the lithium ion cells 110 and the ultracapacitor cells 108 to the output terminal 116.

In some embodiments, the lithium-ion cell stack 102 is in communication with a battery management system (BMS) 114. In some embodiments, the BMS 114 is configured to monitor one or more parameters of the lithium-ion cell stack 102 and/or the one or more lithium-ion cells 110. For instance, the BMS 114 may monitor and/or receive input from one or more sensors, including for example, one or more of a current sensor, a temperature sensor, a total voltage output sensor, an individual cell voltage sensor, a power sensor, and an energy sensor. The BMS 114 may measure one or more battery parameters, which may include one or more of a battery output current, a battery temperature, a battery total voltage output, a battery cell voltage, a battery output power, a battery energy, a battery state of health (SOH), and a battery state of charge (SOC). In some embodiments, the one or more battery parameters (and/or other parameters described herein) are provided to the controller 130 as inputs for determining how to allocate the distribution of power/current from the lithium-ion cell stack 102 and/or the ultracapacitor cell stack 104 to the first terminal 116.

In some embodiments, the ultracapacitor cell stack 104 is in communication with a capacitor management system (CMS) 112. The CMS 112 may monitor and/or receive input from one or more sensors, including for example one or more ultracapacitor cell sensors configured to measure one or more parameters of the ultracapacitor cell stack 104 and/or the one or more ultracapacitor cells 108. For instance, the CMS 112 may include one or more of a current sensor, a temperature sensor, a total voltage output sensor, an individual cell voltage sensor, a power sensor, and an energy sensor. The CMS 112 may measure one or more ultracapacitor parameters, which may include one or more of an ultracapacitor output current, an ultracapacitor temperature, an ultracapacitor total voltage output, an ultracapacitor cell voltage, an ultracapacitor output power, an ultracapacitor energy, an ultracapacitor state of health (SOH), an ultracapacitor state of charge (SOC), an equivalent series resistance (ESR) and a capacitance. In some embodiments, the one or more ultracapacitor parameters (and/or other parameters described herein) are provided to the controller 130 as inputs for determining how to allocate the distribution of power/current from the lithium-ion cell stack 102 and/or the ultracapacitor cell stack 104 to the first terminal 116.

In some embodiments, the hybrid battery 100 includes a DC/DC converter 106. The DC/DC converter 106 may be a bidirectional boost/buck DC/DC converter capable of conducting at least the same current as the ultracapacitor cell stack 104. The DC/DC converter 106 may be in communication with an electronic controller 130. Under the control of the electronic controller 130, the DC/DC converter 106 may switch between boost and buck modes. This time period for this transition is preferably in the order of 25 to 100 microseconds. The electronic controller 130 may control the direction and the magnitude of electrical power flowing through the DC/DC converter 130.

The electronic controller 130 controls the output current from the ultracapacitor cell stack 104 (i.e., the second current). For example, in some embodiments, the DC/DC converter 106 is electrically connected in-series with the ultracapacitor cell stack 104 and the electronic controller 130 adjusts an output voltage of the DC/DC converter 106. Adjusting the output voltage of the DC/DC converter 106 may control an output current from the ultracapacitor cell stack 104, and thus, the electronic controller 130 may selectively control/adjust the output current from the ultracapacitor cell stack 104, which thereby controls an output current from the lithium-ion cell stack 102 (i.e., the remaining load is drawn from the lithium-ion stack 102). In other embodiments, the reverse configuration is possible wherein the DC/DC converter 106 is electrically connected in-series with the lithium-ion cell stack 102. For instance, the DC/DC converter 106 can be positioned between the lithium-ion cell stack 102 and the current sensor 124 to control an output current from the lithium-ion cell stack 102, which thereby controls the output current from the ultracapacitor cell stack 104.

In some embodiments, the electronic controller 130 monitors the voltage of a voltage supply bus and adaptively determines its nominal value, its rate of change, and, optionally, its frequency spectrum content. The hybrid battery 100 may optionally include a switch 128 to protect against reverse polarity voltage.

The hybrid battery 100 may include one or more current sensors configured to measure current at different locations on the circuit and/or communicate a measured current to the electronic controller 130. For example, a first current sensor 120 may be located adjacent to the first terminal 116 to measure a total output current from the hybrid battery 100 (i.e., the total current output from the hybrid battery 100) and/or measure a total input current to the hybrid battery 100 (i.e., the total current input into the hybrid battery 100). A second current sensor 122 may be located adjacent to the ultracapacitor cell stack 104 and measure the output current from the ultracapacitor cell stack 104. In some embodiments, the second current sensor 122 may be positioned between the ultracapacitor cell stack 104 and the DC/DC converter 106. The one or more current sensors 120, 122, 124 may communicate with the CMS 112, the BMS 114, and/or with the electronic controller 130. In some embodiments, the one or more current sensors 120, 122, 124 may communicate directly with the electronic controller 130, and in other embodiments, the one or more current sensors 120, 122, 124 may communicate with the CMS 112 and the BMS 114, and the CMS 112 and the BMS 114 communicate the measured current to the electronic controller 130.

In some embodiments, the electronic controller 130 may receive a first current measurement (i.e., a total input/output current) from the first current sensor 120 and may receive a second current measurement (i.e., an output current from the ultracapacitor cell stack 104) from the second current sensor 122. The electronic controller 130 may calculate an output current from the lithium-ion cell stack 102 by subtracting the second current measurement from the first current measurement. In other words, if the electronic controller 130 measures the total current output and measures the output current from the ultracapacitor cell stack 104, the difference between the total current output and the output current from the ultracapacitor cell stack 104 must be supplied from the lithium-ion cell stack 102 (given there are no other power supply sources within the hybrid battery 100, as in this example).

In some embodiments, a third current sensor 124 may be located adjacent to the lithium-ion cell stack 102 to measure an output current from the lithium-ion cell stack 102. As described above, there way other alternative ways to calculate the output current from the lithium-ion cell stack 102, however, the third current sensor 124 may provide a more accurate current measurement than calculating the output current of the lithium-ion cell stack 102.

In some embodiments, a plurality of current sensors may be used to measure current from the lithium-ion cell stack 102, the ultracapacitor cell stack 104, the lithium-ion cells 110, the ultracapacitor cells 108, and/or combinations thereof. In embodiments including a plurality of lithium-ion cell stacks and/or a plurality of ultracapacitor cell stacks, at least one current sensor may be used on each respective lithium-ion cell stack and/or ultracapacitor cell stack. In this way, the electronic controller 130 is able to monitor the total current supplied by the hybrid battery 100 as well as the first and second currents (i.e., currents from the lithium-ion cell stack 102 and the ultracapacitor cell stack 104, respectively) supplied individually by the lithium-ion cells 110 and the ultracapacitor cells 108, respectively. By selectively controlling the operation of the DC/DC converter 106, the controller 130 is able to directly control the magnitude of the second current provided by the ultracapacitor cells 108, and thereby indirectly control the magnitude of the first current provided by the lithium-ion cells 110. In this way, the controller 130 selectively controls how power is sourced from the lithium-ion cells 110 and the ultracapacitor cells 108. The electronic controller 130 may selectively adjust the output voltage of the DC/DC converter 106 depending on the received lithium-ion cell parameters and/or ultracapacitor cell parameters. For example, the BMS 114 may communicate a lithium-ion cell parameter which determines an available output current of the lithium-ion cell stack 102 (e.g., low battery temperature, low battery SOC, etc.). The electronics controller 130 may adjust the output voltage of the DC/DC converter 106 to thereby increase the output current of the ultracapacitor cell stack 104 to supplement the decreased output current from the lithium-ion cell stack 104.

In some embodiments, one or more features of the hybrid battery 100 may be secured to a printed circuit board assembly (PCBA) 132. For instance, the CMS 112, the BMS 114, the DC/DC converter 106, and the electronics controller 130 may be secured to the PCBA 132. In some embodiments, the hybrid battery 100 may include a low voltage communication port 134. The low voltage communication port 134 may be configured for CAN (Controller Area Network) communication, LIN (Local Interconnect Network) communication, and/or a KL15 ignition key.

The electronic controller 130 may be in communication with the BMS 114 and/or the CMS 112. Thus, the electronic controller 130 may receive one or more lithium-ion cell parameters and/or one or more ultracapacitor cell parameters, including but not limited to: a battery output current, a battery temperature, a battery total voltage output, a battery cell voltage, a battery output power, a battery energy, a battery state of health (SOH), a battery state of charge (SOC), an ultracapacitor output current, an ultracapacitor temperature, an ultracapacitor total voltage output, an ultracapacitor cell voltage, an ultracapacitor output power, an ultracapacitor energy, an ultracapacitor state of health (SOH), and/or an ultracapacitor state of charge (SOC).

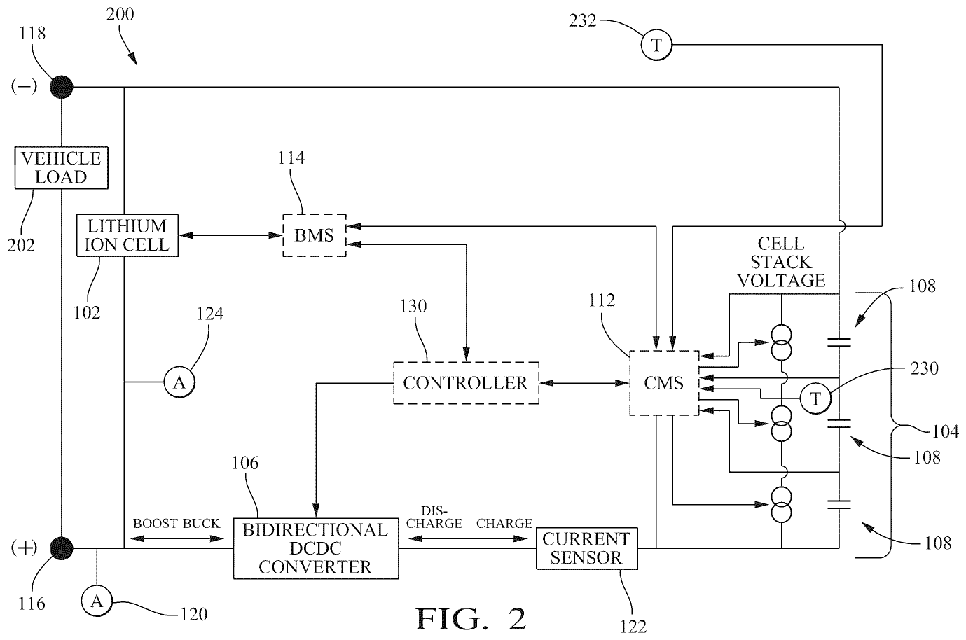

FIG. 2 illustrates a schematic circuit diagram of a hybrid battery 200, according to some embodiments. The hybrid battery 200 may include any and/or all features of the hybrid battery 100 illustrated in FIG. 1 and described above (and vice-versa). The hybrid battery 200 may be electrically connected to a vehicle load 202 at the first terminal (+) 116 and at the second terminal (−) 118.

The hybrid battery 200 may include the lithium-ion cell stack 102 and the ultracapacitor cell stack 104 electrically coupled in-parallel. In some embodiments, each of the ultracapacitor cells 108 may be electrically connected in-series with one another. Each of the ultracapacitor cells 108 may have bidirectional communication with the CMS 112. For example, bidirectional communication may include communication in a first direction (i.e., from the ultracapacitor cells 108 to the CMS 112 via the CMS 112 receiving sensor data/ultracapacitor parameters) and communication in a second direction (i.e., from the CMS 112 to the ultracapacitor cells 108, as for example, the CMS 112 may communicate a maximum charge level to one or more ultracapacitor cells 108). In some embodiments, each of the lithium-ion cells (not shown in FIG. 2) may be electrically connected in-series with one another. Each of the lithium-ion cells may have bidirectional communication with the BMS 114. For example bidirectional communication may include communication in a first direction (i.e., from the lithium-ion cells 110 to the BMS 114 via the CMS 114 receiving sensor data/battery parameters) and communication in a second direction (i.e., from the BMS 114 to the lithium-ion cells 110, as for example, the BMS 112 may communicate a maximum charge level to one or more lithium-ion cells 110).

In some embodiments, the CMS 112 and/or the BMS 114 may have bidirectional communication with the electronics controller 130. In some embodiments, the controller 130 monitors the current measured by the current sensors 120, 122 and/or 124. In some embodiments, the BMS monitors the first current provided by the lithium-ion cell stack 102 with the current sensor 124. In some embodiments, the CMS 112 monitors the current provided by the ultracapacitor cell stack 104 via the current sensor 122. In some embodiments, the BMS 114 and/or the CMS 112 communicate the measured first and/or second current to the controller 130. In other embodiments, the electronic controller 130 directly monitors these currents. The electronics controller 130 may receive lithium-ion cell parameters from the BMS 114, ultracapacitor cell parameters from the CMS 112, and/or current measurements from the current sensors 120, 122, 124 and adjust an output voltage of the DC/DC converter 106 to control a current output from the ultracapacitor cell stack 104.

The hybrid battery 200 may be configured to provide a high power output. The vehicle load 202 may include one or more vehicular systems, including for example, vehicle lighting (interior and exterior), vehicle braking (e.g., ABS), vehicle ignition, vehicle display, vehicle climate control, power steering, etc. The vehicle load 202 may continuously change as the one or more vehicular systems operate, and in some embodiments, the vehicle load 202 may undergo rapid or transient spikes.

For example, if a vehicle system has a sudden demand for high power (e.g., an anti-lock braking system (ABS)), the vehicle load 202 may rapidly increase and demand high-power (high output current for short time period) from the hybrid battery 200. The vehicle load 202 may be measured by the first current sensor 120 and may be communicated to the electronics controller 130. The electronics controller 130 may calculate a target ultracapacitor output current and/or a target lithium-ion output current to meet the vehicle load 202. The electronics controller 130 may modify the output voltage of the DC/DC converter 106 to adjust the output current of the ultracapacitor cell stack 104 to the target ultracapacitor output current. The ultracapacitor cell stack 104 may be optimized to provide high-power for transient time periods (i.e., less than 2 seconds), whereas the lithium-ion cell stack 102 may be designed to provide power for long periods (i.e., hours or minutes). Thus, the percentage of total output current from the ultracapacitor cell stack (uCap %) may be greater than the percentage of total output current from the lithium-ion cell stack (li-ion %) during short-term, load current spikes.

In one example, the vehicle load 202 may draw 10 A (I_{LOAD}=10 A). The first current sensor 120 may measure the I_{LOAD} and communicate the measured current to the electronics controller 130. The electronics controller 130 may analyze one or more input parameters from the CMS 112, the BMS 114, and/or the current sensors 120, 122, 124 to determine an optimal distribution of power from the ultracapacitor cell stack 104 and the lithium-ion cell stack (i.e., the electronics controller 130 calculates an optimal uCap % and li-ion %). For example, the electronics controller 130 may calculate the uCap % to be 60%. The desired current to be drawn from the ultracapacitor cell stack 104 would be 6 A (I_{UCAP}=6 A) and the remaining load would be drawn from the lithium-ion cell stack 102 (I_{LI-ION}=4 A). The electronics controller 130 may adjust the output voltage of the DC/DC converter 106 to thereby draw 6 A from the ultracapacitor cell stack 104.

In some embodiments, the uCap % may be influenced by the lithium-ion cell parameters from the BMS 114 and/or the ultracapacitor cell parameters from the CMS 112. For example, if the BMS 114 measures a temperature of the lithium-ion cell stack 102 to be lower than a threshold level, the electronics controller 130 may limit the current provided by the lithium-ion cell stack 102 to avoid rapid charging of the lithium-ion cell stack 102 at low temperatures (which could damage/degrade the lithium-ion cell stack 102).

In some embodiments, the CMS 112 may have bidirectional communication with the BMS 114. For example, the CMS 112 may include a cell temperature sensor 230 and/or an external temperature sensor 232. Temperature measurements from the cell temperature sensor 230 and/or the external temperature sensor 232 may be shared between the BMS 114 and the CMS 112. Such configuration is beneficial because it reduces the total number of sensors in the hybrid battery, i.e., the BMS 114 and CMS 112 share sensor data between each other.

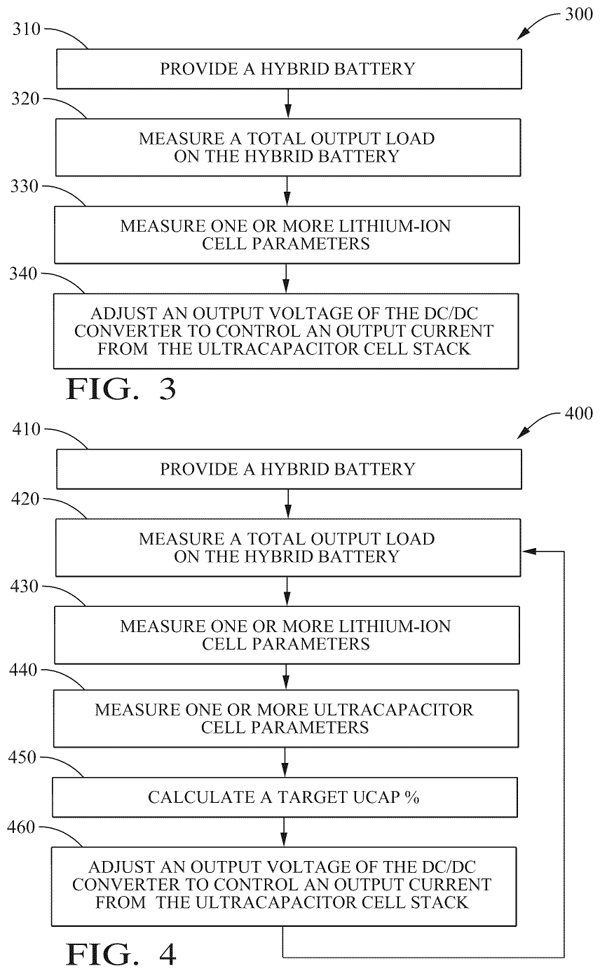

FIG. 3 illustrates a flow chart for a method 300 of delivering electric power to a vehicle, according to some embodiments. At step 310 a hybrid battery is provided. The hybrid battery may include any or all features of the hybrid battery 100 and/or the hybrid battery 200 described above and illustrated in FIGS. 1-2. At step 320 a total output load on the hybrid battery 200 is measured. The total output load may be measured at or near a terminal 116, 118 of the hybrid battery 200 with the first current sensor 120.

At step 330 one or more lithium-ion cell parameters is measured. The lithium-ion cell parameters may be measured by the BMS 114, which may include one or more of a current sensor, a temperature sensor, a total voltage output sensor, an individual cell voltage sensor, a power sensor, and an energy sensor. The BMS 114 may measure one or more lithium-ion cell parameters, which may include one or more of a lithium-ion output current, a lithium-ion cell temperature, a lithium-ion cell stack total voltage output, a lithium-ion cell voltage, a lithium-ion output power, a lithium-ion energy, a lithium-ion state of health (SOH), and a lithium-ion state of charge (SOC). In some embodiments, at step 330 a first current from the lithium-ion cell stack 102 and a second current from the ultracapacitor cell stack 104 is determined.

At step 340 an output voltage of the DC/DC converter is adjusted with the electronics controller to control a current from the ultracapacitor cell stack. The DC/DC converter may include the DC/DC converter 106 described above, and the electronics controller may include the electronics controller 130 described above. The total output load on the hybrid battery 200 and the one or more lithium-ion cell parameters may be input into the electronics controller 130. The electronics controller 130 may adjust the output voltage of the DC/DC converter 106 to thereby adjust the current output from the ultracapacitor cell stack 104.

In some embodiments, the method 300 may include generating a lithium-ion power threshold wherein the electronics controller 130 inputs the lithium-ion cell parameters measured by the BMS 114 and calculates a maximum power that the lithium-ion cell stack 102 may output without being damaged or degraded. The method 300 may include comparing the lithium-ion power threshold to the total output load on the hybrid battery. If the total output load on the hybrid battery is greater than the lithium-ion power threshold, the electronics controller 130 may adjust an output voltage of the DC/DC converter 106 to increase an output current from the ultracapacitor cell stack 104.

FIG. 4 illustrates a flow chart for a method 400 of delivering electric power to a vehicle, according to some embodiments. At step 410 a hybrid battery is provided. The hybrid battery may include any or all features of the hybrid battery 100 and/or the hybrid battery 200 described above and illustrated in FIGS. 1-2. At step 420 a total output load on the hybrid battery 200 is measured. The total output load may be measured at or near a terminal 116, 118 of the hybrid battery 200 with the first current sensor 120.

At step 430 one or more lithium-ion cell parameters is measured. The lithium-ion cell parameters may be measured by the BMS 114, which may include one or more of a current sensor, a temperature sensor, a total voltage output sensor, an individual cell voltage sensor, a power sensor, and an energy sensor. The BMS 114 may measure one or more lithium-ion cell parameters, which may include one or more of a lithium-ion output current, a lithium-ion cell temperature, a lithium-ion cell stack total voltage output, a lithium-ion cell voltage, a lithium-ion output power, a lithium-ion energy, a lithium-ion state of health (SOH), and a lithium-ion state of charge (SOC).

At step 440 one or more ultracapacitor cell parameters is measured. The ultracapacitor cell parameters may be measured by the CMS 112, which may include one or more of a current sensor, a temperature sensor, a total voltage output sensor, an individual cell voltage sensor, a power sensor, and an energy sensor. The CMS 112 may measure one or more ultracapacitor cell parameters, which may include one or more of a ultracapacitor output current, a ultracapacitor cell temperature, a ultracapacitor cell stack total voltage output, a ultracapacitor cell voltage, a ultracapacitor output power, a ultracapacitor energy, a ultracapacitor state of health (SOH), and a ultracapacitor state of charge (SOC).

At step 450 a target uCap % is calculated. The uCap % is a percentage of the total output current of the hybrid battery 200 supplied by the ultracapacitor cell stack 104. The target uCap % may be calculated by the electronics controller 130 based on input data including but not limited to: the one or more ultracapacitor cell parameters, the one or more lithium-ion cell parameters, and the current measurements (e.g., from the current sensors 120, 122, and/or 124). In some embodiments, a target uCap % is calculated because the controller 130 controls the DC/DC converted 106 to directly control the second current supplied by the ultracapacitor cell stack 104. However, by controlling the uCap %, the controller 130 is also directing the magnitude of the current provided by the lithium-ion cells stack 102 (i.e., the first current). In some embodiments, the electronics controller 130 may include a uCap % function wherein one or more of ultracapacitor cell parameters, lithium-ion cell parameters, and current measurements are input into the uCap % function to generate a target uCap %.

At step 460 an output voltage of the DC/DC converter 106 is adjusted to control a current output from the ultracapacitor cell stack 104. The output voltage of the DC/DC converter 106 may be controlled to adjust the output current of the ultracapacitor cell stack 106 such that the ratio of output current of the ultracapacitor cell stack 106 to total output current of the hybrid battery matches the target uCap %.

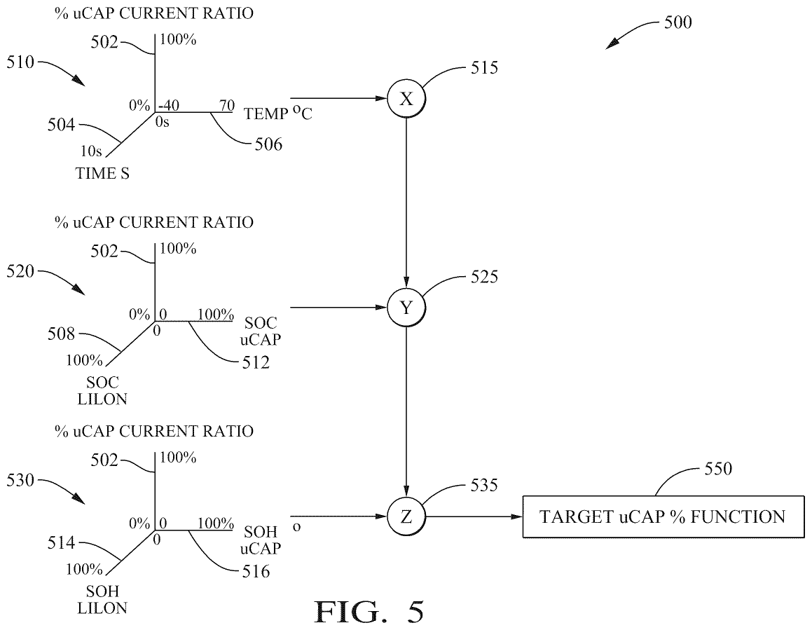

FIG. 5 illustrates an exemplary flow chart 500 of input parameters for a uCap % function, according to some embodiments. In some embodiments, the uCap % function illustrated in FIG. 5 may be included in step 450 of the method 400, calculating a target uCap %. The flow chart 500 may include a first set of parameters 510, a second set of parameters 520, and a third set of parameters 530. In some embodiments, calculating the target uCap % may include analyzing a set of parameters (i.e., one or more lithium-ion cell parameters, one or more ultracapacitor cell parameters, and/or one or more current measurements) and determining a weight based on the set of parameters. The weight may impact the target uCap %. In some embodiments, each of the first set of parameters 510, the second set of parameters 520, and the third set of parameters 530 are vector models wherein one or more input parameters are input into a respective parameter set and an output vector indicative of uCap % is generated.

For instance, in one example the first set of parameters 510 may include a temperature parameter 506 and a time parameter 504. The temperature parameter 506 and the time parameter 504 may determine a % uCap current ratio 502 which may be output as a first weight 515. For example, if the temperature parameter 506 is low (e.g., subzero temperature) and the time parameter 504 is low (e.g., under 1 second), the lithium-ion cell stack 102 may be damaged by a rapid high-power charging at low temperatures. Therefore, the % uCap current ratio 502 may be high (i.e., above 50%).

In another example, the second set of parameters 520 may include a lithium-ion SOC parameter 508 and an ultracapacitor SOC parameter 512. The lithium-ion SOC parameter 508 and the ultracapacitor SOC parameter 512 may determine the % uCap current ratio 502 which may be output as a second weight 525. For example, if the lithium-ion SOC parameter 508 is higher than the ultracapacitor SOC parameter 512, the % uCap current ratio 502 may be decreased, as the ultracapacitor cell stack 104 has less available energy than the lithium-ion cell stack 102.

In another example, the third set of parameters 530 may include a lithium-ion SOH parameter 514 and an ultracapacitor SOH parameter 516. The lithium-ion SOH parameter 514 and the ultracapacitor SOH parameter 516 may determine the % uCap current ratio 502 which may be output as a third weight 535. For example, if the lithium-ion SOH parameter 512 is lower than the ultracapacitor SOH parameter 516, the % uCap current ratio 502 may be increased to prevent further degradation of the lithium-ion cell stack 102.

In some embodiments, a plurality of sets of parameters may generate a plurality of weights (e.g., X, Y, Z) to determine a % uCap current ratio. The electronics controller 130 may receive input from the CMS 112, the BMS 114, and/or the current sensors 120, 122, 124 and determine a plurality of weights (e.g., X, Y, Z) based on the inputs. In some embodiments, the plurality of weights are input into a target uCap % function 550. The target uCap % function may output a target uCap %, and the controller 130 may adjust the output current of the ultracapacitor stack to meet the target uCap %. In some embodiments, hybrid battery life (i.e., SOH of individual cells/components) is increased via smart management of current. For example, an external load may be intelligently allocated between the ultracapacitor cell stack and the lithium-ion cell stack to maximize lifetime of the hybrid battery without sacrificing performance.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

What is claimed is:

1. A hybrid battery for supplying electric power to a vehicle, the hybrid battery comprising:
at least one terminal;
one or more lithium-ion cells connected to supply a first current to the at least one terminal;
one or more ultracapacitor cells;
a DC/DC converter coupled in-series between the at least one terminal and the one or more ultracapacitor cells, the one or more ultracapacitor cells and the DC/DC converter are connected to supply a second current to the at least one terminal, and the one or more lithium-ion cells are connected in parallel with the one or more ultracapacitor cells and the DC/DC converter; and
a controller in communication with the DC/DC converter to selectively modify the second current provided to the at least one terminal.

2. The hybrid battery of claim 1 further comprising:
a capacitor management system (CMS) configured to monitor one or more first parameters associated with the one or more ultracapacitor cells.

3. The hybrid battery of claim 2 further comprising:
a battery management system (BMS) configured to monitor one or more second parameters associated with the one or more lithium-ion cells.

4. The hybrid battery of claim 1, wherein the hybrid battery provides a total output current to an external load, wherein the total output current is a sum of the first current from the one or more lithium-ion cells and the second current from the one or more ultracapacitor cells.

5. The hybrid battery of claim 4 further comprising:
a first current sensor to measure the total output current at the at least one terminal; and
a second current sensor to measure the second current between the DC/DC converter and the one or more ultracapacitor cells,
wherein the controller receives a first current measurement from the first current sensor and a second current measurement from the second current sensor, and
wherein the controller adjusts an output voltage of the DC/DC converter.

6. The hybrid battery of claim 5, further comprising:
a third current sensor to measure the first current from the one or more lithium-ion cells,
wherein the controller receives a third current measurement from the third current sensor, and
wherein the controller adjusts the output voltage of the DC/DC converter based on the first current measurement.

7. The hybrid battery of claim 2, wherein the controller modifies an output voltage of the DC/DC converter based, at least in part, on the one or more monitored first parameters.

8. The hybrid battery of claim 3, wherein the controller modifies an output voltage of the DC/DC converter based, at least in part, on the one or more monitored second parameters.

9. The hybrid battery of claim 3, wherein the one or more monitored first parameters and/or the one or more monitored second parameters are measured by at least one sensor, including one or more of a current sensor, a temperature sensor, a total voltage output sensor, an individual cell voltage sensor, a power sensor, and/or an energy sensor.

10. A method of delivering electric power to a vehicle, the method comprising:
measuring a total output current provided by a hybrid battery with a first current sensor, the hybrid battery including:
at least one terminal;
one or more lithium-ion cells connected to supply a first current to the terminal;
one or more ultracapacitor cells;
a DC/DC converter coupled in-series between the terminal and the one or more ultracapacitor cells, the one or more ultracapacitor cells and the DC/DC converter are connected to supply a second current to the terminal, and the lithium-ion cells are connected in parallel with the one or more ultracapacitor cells and the DC/DC converter; and
controlling the DC/DC converter based on the measured total output current to control a second current provided by the one or more ultracapacitor cells.

11. The method of claim 10 further comprising:
generating a lithium-ion power threshold based on one or more of a state of charge of the lithium-ion cells, a state of health of the lithium-ion cells, and a temperature of the lithium-ion cells.

12. The method of claim 11 further comprising:
comparing the total output current to the lithium-ion power threshold;
providing at least some power from the ultracapacitor cells if the total output current is greater than the lithium-ion power threshold.

13. The method of claim 11, wherein the hybrid battery includes:
a capacitor management system (CMS) in communication with one or more first sensors, and
a battery management system (BMS) in communication with one or more second sensors,
wherein the CMS and the BMS communicate with a controller.

14. The method of claim 13, further comprising:
measuring one or more battery parameters with the BMS, the one or more battery parameters include one or more of a battery output current, a battery temperature, a battery total voltage output, a battery cell voltage, a battery output power, a battery energy, a battery state of health (SOH), and a battery state of charge (SOC),
wherein generating the lithium-ion power threshold is based, at least in part, on one or more of the battery parameters.

15. The method of claim 13, further comprising:
measuring one or more capacitor parameters with the CMS, the one or more capacitor parameters include one or more of a capacitor output current, a capacitor temperature, a capacitor total voltage output, a capacitor cell voltage, a capacitor output power, a capacitor energy, a capacitor state of health (SOH), and a capacitor state of charge (SOC),
wherein generating the lithium-ion power threshold is based, at least in part, on one or more of the capacitor parameters.

16. The method of claim 10, further comprising:
measuring an ultracapacitor output current with a second current sensor;
determining a first current of the one or more lithium-ion cells; and
adjusting an output voltage of the DC/DC converter with a controller to control the second current from the one or more ultracapacitor cells,
wherein a sum of the first current and the second current equal the total output current.

17. A vehicular battery system, comprising:
a hybrid battery, including:
an output terminal,
a lithium-ion cell stack,
an ultracapacitor cell stack,
a DC/DC converter electrically coupled in-series with the ultracapacitor cell stack, and
a first current sensor measuring a first current at the output terminal;
a battery management system (BMS) in communication with a battery sensor to measure one or more lithium-ion cell stack parameters;
a capacitor management system (CMS) in communication with a capacitor sensor to measure one or more ultracapacitor cell stack parameters; and
a controller in communication with the BMS, with the CMS, and with the DC/DC converter, wherein the controller selectively adjusts an output current from the ultracapacitor cell stack.

18. The vehicular battery system of claim 17, wherein the controller selectively adjusts an output voltage of the DC/DC converter to adjust the output current from the ultracapacitor cell stack.

19. The vehicular battery system of claim 18, wherein the controller generates a lithium-ion power threshold based on the one or more measured ultracapacitor cell stack parameters and/or the one or more measured lithium-ion cell stack parameters.

20. The vehicular battery system of claim 19, wherein the hybrid battery includes a second current sensor measuring a second current from the ultracapacitor cell stack, wherein the controller determines a lithium-ion load by subtracting the second current from the first current.
